(19) United States
(12) Patent Application Publication
(10) Pub. No.: US 2008/0118886 A1
(43) Pub. Date: May 22, 2008

(54) APPARATUS FOR DENTAL OCT IMAGING

(76) Inventors: Rongguang Liang, Penfield, NY (US); Michael A. Marcus, Honeoye Falls, NY (US); David L. Patton, Webster, NY (US); Laurie L. Voci, Victor, NY (US); Victor C. Wong, Rochester, NY (US); Paul O. McLaughlin, Rochester, NY (US); Mark E. Bridges, Spencerport, NY (US)

Correspondence Address: Carestream Health Inc,, 150 Verona Street, Rochester, NY, 14608, US

(21) Appl. No.: 11/561,971

(22) Filed: Nov. 21, 2006

(51) Int. Cl. A61C 3/00

(52) U.S. Cl. 433/29

(57) ABSTRACT

An apparatus (10) for obtaining an image of a tooth (20) includes an image sensor and a white light source (12) providing broadband polychromatic light and an ultraviolet light source providing narrow-band light. A combiner (15) directs broadband polychromatic light and narrow band light along a common illumination path to illuminate the tooth. A polarization beamsplitter (18) directs polarized light from the illumination path along an optical axis (216). An optical coherence tomography (OCT) imaging apparatus (70) splits the low coherence light into a sample path and a reference path and a dichroic element (78) directs the polarized illumination and the sample path low coherence light along the optical axis. An image processor (100) identifies a region of interest according to either a white light image (124), a fluorescent light image (120), or both and the OCT imaging apparatus obtains an OCT image over the region of interest.

### CROSS REFERENCE TO RELATED APPLICATIONS

Reference is made to commonly-assigned copending U.S. application Ser. No. 11/262,869, filed Oct. 31, 2005, entitled METHOD FOR DETECTION OF CARIES, by Wong et al.; U.S. application Ser. No. 11/408,360, filed Apr. 21, 2006, entitled OPTICAL DETECTION OF DENTAL CARIES by Wong et al.; U.S. patent application Ser. No. 11/530,987, filed Sep. 12, 2006, entitled APPARATUS FOR CARIES DETECTION, by Liang et al.; and U.S. patent application Ser. No. 11/530,913, filed Sep. 12, 2006, entitled LOW COHERENCE DENTAL OCT IMAGING, by Liang et al., the disclosures of which are incorporated herein.

### FIELD OF THE INVENTION

This invention generally relates to methods and apparatus for dental imaging and more particularly relates to an apparatus for caries detection using visible light, fluorescent light, and low coherence OCT imaging.

### BACKGROUND OF THE INVENTION

In spite of improvements in detection, treatment, and prevention techniques, dental caries remains a widely prevalent condition affecting people of all age groups. If not properly and promptly treated, caries can lead to permanent tooth damage and even to loss of teeth.

Traditional methods for caries detection include visual examination and tactile probing with a sharp dental explorer device, often assisted by radiographic (x-ray) imaging. Detection using these methods can be somewhat subjective, varying in accuracy due to many factors, including practitioner expertise, location of the infected site, extent of infection, viewing conditions, accuracy of x-ray equipment and processing, and other factors. There are also hazards associated with conventional detection techniques, including the risk of damaging weakened teeth and spreading infection with tactile methods as well as exposure to x-ray radiation. By the time caries is evident under visual and tactile examination, the disease is generally in an advanced stage, requiring a filling and, if not timely treated, possibly leading to tooth loss.

In response to the need for improved caries detection methods, there has been considerable interest in improved imaging techniques that do not employ x-rays. One method that has been commercialized employs fluorescence, caused when teeth are illuminated with high intensity blue light. This technique, termed quantitative light-induced fluorescence (QLF), operates on the principle that sound, healthy tooth enamel yields a higher intensity of fluorescence under excitation from some wavelengths than does de-mineralized enamel that has been damaged by caries infection. The strong correlation between mineral loss and loss of fluorescence for blue light excitation is then used to identify and assess carious areas of the tooth. A different relationship has been found for red light excitation, a region of the spectrum for which bacteria and bacterial by-products in carious regions absorb and fluoresce more pronouncedly than do healthy areas.

Among proposed solutions for optical detection of caries are the following:
U.S. Pat. No. 4,515,476 (Ingmar) discloses use of a laser for providing excitation energy that generates fluorescence at some other wavelength for locating carious areas.
U.S. Pat. No. 6,231,338 (de Josselin de Jong et al.) discloses an imaging apparatus for identifying dental caries using fluorescence detection.
U.S. Patent Application Publication No. 2004/0240716 (de Josselin de Jong et al.) discloses methods for improved image analysis for images obtained from fluorescing tissue.

Among commercialized products for dental imaging using fluorescence behavior is the QLF Clinical System from Inspektor Research Systems BV, Amsterdam, The Netherlands. Using a different approach, the Diagnodent Laser Caries Detection Aid from KaVo Dental Corporation, Lake Zurich, Ill., detects caries activity monitoring the intensity of fluorescence of bacterial by-products under illumination from red light.

U.S. Patent Application Publication No. 2004/0202356 (Stookey et al.) describes mathematical processing of spectral changes in fluorescence in order to detect caries in different stages with improved accuracy. Acknowledging the difficulty of early detection when using spectral fluorescence measurements, the '2356 Stookey et al. disclosure describes approaches for enhancing the spectral values obtained, effecting a transformation of the spectral data that is adapted to the spectral response of the camera that obtains the fluorescent image.

While the disclosed methods and apparatus show promise in providing non-invasive, non-ionizing imaging methods for caries detection, there is still room for improvement. One recognized drawback with existing techniques that employ fluorescence imaging relates to image contrast. The image provided by fluorescence generation techniques such as QLF can be difficult to assess due to relatively poor contrast between healthy and infected areas. As noted in the '2356 Stookey et al. disclosure, spectral and intensity changes for incipient caries can be very slight, making it difficult to differentiate non-diseased tooth surface irregularities from incipient caries.

Overall, it is well recognized that, with fluorescence techniques, the image contrast that is obtained corresponds to the severity of the condition. Accurate identification of caries using these techniques often requires that the condition be at a more advanced stage, beyond incipient or early caries, because the difference in fluorescence between carious and sound tooth structure is very small for caries at an early stage. In such cases, detection accuracy using fluorescence techniques may not show marked improvement over conventional methods. Because of this shortcoming, the use of fluorescence effects appears to have some practical limits that prevent accurate diagnosis of incipient caries. As a result, a caries condition may continue undetected until it is more serious, requiring a filling, for example.

Detection of caries at very early stages is of particular interest for preventive dentistry. As noted earlier, conventional techniques generally fail to detect caries at a stage at which the condition can be reversed. As a general rule of thumb, incipient caries is a lesion that has not penetrated substantially into the tooth enamel. Where such a caries lesion is identified before it threatens the dentin portion of the tooth, remineralization can often be accomplished, reversing the early damage and preventing the need for a filling. More advanced caries, however, grows increasingly more difficult to treat, most often requiring some type of filling or other type of intervention.

In order to take advantage of opportunities for non-invasive dental techniques to forestall caries, it is necessary that caries be detected at the onset. In many cases, as is acknowledged in the '2356 Stookey et al. disclosure, this level of detection has been found to be difficult to achieve using existing fluorescence imaging techniques, such as QLF. As a result, early caries can continue undetected, so that by the time positive detection is obtained, the opportunity for reversal using low-cost preventive measures can be lost.

U.S. Pat. No. 6,522,407 (Everett et al.) discloses the application of polarimetry principles to dental imaging. One system described in the Everett et al. '407 teaching provides a first polarizer in the illumination path for directing a polarized light to the tooth. A second polarizer is provided in the path of reflected light. In one position, the polarizer transmits light of a horizontal polarization. Then, the polarizer is oriented to transmit light having an orthogonal polarization. Intensity of these two polarization states of the reflected light can then be compared to calculate the degree of depolarization of light scattered from the tooth. The result of this comparison then provides information on a detected caries infection.

While the approach disclosed in the Everett et al. '407 patent takes advantage of polarization differences that can result from backscattering of light, the apparatus and methods described therein require the use of multiple polarizers, one in the illumination path, the other in the imaging path. Moreover, the imaging path polarizer must somehow be readily switchable between a reference polarization state and its orthogonal polarization state. Thus, this solution has inherent disadvantages for allowing a reduced package size for caries detection optics. It would be advantageous to provide a simpler solution for caries imaging, a solution not concerned with measuring a degree of depolarization, thus using a smaller number of components and not requiring switchable orientation of a polarizer between one of two positions.

As is described in one embodiment of the Everett et al. '407 patent disclosure, optical coherence tomography (OCT) has been proposed as a tool for dental and periodontal imaging, as well as for other medical imaging applications. For example:
U.S. Patent Application Publication No. 2005/0024646 (Quadling et al.) describes the use of time-domain and Fourier-domain OCT systems for dental imaging;
U.S. Pat. No. 5,570,182 (Nathel et al.) describes the use of OCT for imaging of tooth and gum structures;
U.S. Pat. No. 6,179,611 (Everett et al.) describes a dental explorer tool that is configured to provide a scanned OCT image;
Japanese Patent Application Publication No. JP 2004-344260 (Kunitoshi et al.) discloses an optical diagnostic apparatus equipped with a camera for visual observation of a tooth and use of visible light for a surface image, with OCT apparatus for scanning the indicated region of a surface image by signal light;
U.S. Patent Application Publication No. 2005/0283058 (Choo-Smith et al.) describes a method for combining OCT with Raman spectroscopy; and

U.S. Pat. No. 5,321,501 (Swanson et al.) describes principles of OCT scanning and measurement as used in medical imaging applications.

In addition, a number of published articles describe OCT imaging, including:
“In vivo imaging of hard and soft tissue of the oral cavity” by Feldchtein, et al., available from Optics Express, Vol. 3, No. 6, pp. 239-250, 14 Sep. 1998, discloses the use of OCT using multiple wavelengths;
“Dental OCT” by Colston, Jr. et al., available from Optics Express, Vol. 3, No. 6, pp. 230-238, discloses the use of an OCT scanning system with improved performance and reduced sensitivity to optical birefringence;
“Investigations of soft and hard tissues in oral cavity by Spectral Domain Optical Coherence Tomography” by Madjarova et al. from Coherence Domain Optical Methods and Optical Coherence Tomography in Biomedicine, Processes of SPIE, Vol. 6079 (2006), describes imaging methods for teeth using Fourier domain OCT; and
“Optical Coherence Tomography in Dentistry” by Bill W. Colston Jr. et al. in Handbook of Optical Coherence Tomography edited by Brett E Bouma and Guillermo J. Tearney, pp. 591-612, Marcel Dekker Inc., New York 2002, provides an overview of OCT in dentistry.

While OCT solutions, such as those described above, can provide very detailed imaging of structure beneath the surface of a tooth, OCT imaging itself can be time-consuming and computation-intensive. OCT images would be most valuable if obtained within one or more local regions of interest, rather than obtained over widespread areas. That is, once a dental professional identifies a specific area of interest, then OCT imaging could be directed to that particular area only.

Conventional OCT imaging approaches require the operator to apply the imaging probe to the specific area of the tooth that is to be imaged in order to obtain the OCT image. The operator must solve the problem of correct probe positioning and orientation, which can make it difficult to obtain the OCT scan image that is of most interest.

U.S. Pat. No. 6,507,747 (Gowda et al.) describes an optical imaging probe that includes both a spectroscopic imaging probe element and an OCT imaging probe element. This device uses a fluorescence image to guide an OCT scan. However, it does not teach how to select the region for OCT scanning and how to set up and implement the OCT scan.

While methods and apparatus for combined area imaging and OCT scanning have been proposed, however, there remains considerable room for improvement. Optical component configurations disclosed in the cited patents and applications fall short of what is needed for a dental imaging apparatus that combines these imaging functions with suitable image quality and is yet compact and easy to use.

Thus, it can be seen that there is a need for a dental imaging apparatus that provides both area and OCT imaging in a compact package.

### SUMMARY OF THE INVENTION

Briefly, according to one aspect of the present invention an apparatus for obtaining an image of a tooth includes an image sensor and a white light source providing broadband polychromatic light and an ultraviolet light source providing narrow-band light. A combiner directs broadband polychromatic light and narrow band light along a common illumination path to illuminate the tooth. A polarization beamsplitter directs polarized light from the illumination path along an optical axis. An optical coherence tomography (OCT) imaging apparatus splits the low coherence light into a sample path and a reference path and a dichroic element directs the polarized illumination and the sample path low coherence light along the optical axis. An image processor identifies a region of interest according to either a white light image, a fluorescent light image, or both and the OCT imaging apparatus obtains an OCT image over the region of interest.

The use of image analysis logic for determining, from area images, the region of interest for OCT scanning is a feature of the present invention.

The method of the present invention is advantaged over earlier methods for OCT imaging in that it combines the benefits of area imaging for detecting a region of interest and OCT imaging for detailed assessment over that region.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1A is a schematic block diagram of an imaging apparatus for caries detection providing both area imaging and OCT imaging;

FIG. 1B is a schematic block diagram showing components of an OCT imaging system;

FIG. 1C is a logic flow diagram of a sequence of operator steps that are used to obtain an OCT image in one embodiment;

FIG. 2A is a schematic block diagram of an imaging apparatus for caries detection providing both fluorescent area imaging and OCT imaging;

FIG. 2B is a schematic block diagram of an imaging apparatus for caries detection providing both area imaging and OCT imaging and using multiple light sources;

FIG. 3 is a schematic diagram showing a component arrangement in an alternate embodiment;

FIG. 4 is a schematic diagram showing component arrangement in a probe embodiment;

FIG. 5 is a schematic diagram showing component arrangement in an alternate probe embodiment, with connected processing components;

FIG. 6 is a plan view showing the relation of surface area images to an OCT scan obtained using the methods of the present invention;

FIG. 7 is a plan view of a display showing different images obtained using the apparatus of the present invention;

FIG. 8 shows an operator interface sequence for specifying a line scan in one embodiment;

FIG. 9 shows an operator interface sequence for adjusting the position of a line scan;

FIG. 10 shows an operator interface sequence for adjusting the position of a line scan;

FIG. 11 shows an operator interface sequence for specifying the position of an area scan;

FIG. 12 shows an operator interface sequence for specifying the position of an area scan;

FIG. 13 is a schematic diagram showing an auto focus arrangement;

FIG. 14 is a schematic diagram showing an alternate auto focus arrangement;

FIG. 15 is a schematic diagram showing an alternate auto focus arrangement with a single light source;

FIG. 16 is a sequence of side views showing how auto focus senses the focus setting;

FIG. 17 is a schematic diagram showing an embodiment using a relay lens;

FIG. 18 is a schematic diagram showing an alternate embodiment with the area imaging lenses in the front end of the probe.;

FIG. 19 is a schematic diagram showing an alternate embodiment using a scanning optical fiber;

FIG. 20 is the optical diagram to implement fiber optical scanning; and

FIGS. 21A and 21B are schematic diagrams showing a probe embodiment in different tilt positions.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The present invention combines area imaging capabilities for identifying a region or regions of interest on the tooth surface with OCT imaging capabilities for obtaining detailed OCT scan data over a specified portion of the tooth corresponding to a portion of the region of interest. A region of interest is defined as a region of the tooth which has features indicative of potential caries sites or exhibits other defects which would warrant further investigation by OCT imaging. In order to understand the nature and scope of the present invention, it is instructive to first understand its area imaging capabilities. OCT capabilities are then described subsequently. A variety of area imaging embodiments can be combined with an OCT embodiment as described below.

### Surface Area Imaging

As noted in the preceding background section, it is known that fluorescence can be used to detect dental caries using either of two characteristic responses: First, excitation by a blue light source causes healthy tooth tissue to fluoresce in the green spectrum. Secondly, excitation by a red light source can cause bacterial by-products, such as those indicating caries, to fluoresce in the red spectrum.

In order for an understanding of how light is used in the present invention, it is important to give more precise definition to the terms “reflectance” and “backscattering” as they are used in biomedical applications in general and, more particularly, in the method and apparatus of the present invention. In broadest optical parlance, reflectance generally denotes the sum total of both specular reflectance and scattered reflectance. (Specular reflection is that component of the excitation light that is reflected by the tooth surface at the same angle as the incident angle.) In biomedical applications, however, as in the dental application of the present invention, the specular component of reflectance is of no interest and is, instead, generally detrimental to obtaining an image or measurement from a sample. The component of reflectance that is of interest for the present application is from backscattered light only. Specular reflectance must be blocked or otherwise removed from the imaging path. With this distinction in mind, the term “backscattered reflectance” is used in the present application to denote the component of reflectance that is of interest. “Backscattered reflectance” is defined as that component of the excitation light that is elastically backscattered over a wide range of angles by the illuminated tooth structure. “Reflectance image” data, as this term is used in the present invention, refers to image data obtained from backscattered reflectance only, since specular reflectance is blocked or kept to a minimum. In the scientific literature, backscattered reflectance may also be referred to as back reflectance or simply as backscattering. Backscattered reflectance is at the same wavelength as the excitation light.

It has been shown that light scattering properties differ between sound and carious dental regions. In particular, reflectance of light from the illuminated area can be at measurably different levels for normal versus carious areas. This change in reflectance, taken alone, may not be sufficiently pronounced to be of diagnostic value when considered by itself, since this effect is very slight, although detectable. For more advanced stages of caries, for example, backscattered reflectance may be less effective an indicator than at earlier stages.

In conventional fluorescence measurements such as those obtained using QLF techniques, reflectance itself is an effect that is avoided rather than utilized. A filter is usually employed to block off all excitation light from reaching the detection device. For this reason, the slight but perceptible change in backscattered reflectance from excitation light has received little attention for diagnosing caries.

The inventors have found, however, that this backscattered reflectance change can be used in conjunction with the fluorescent effects to more clearly and more accurately pinpoint a carious location. Moreover, the inventors have observed that the change in light scattering activity, while it can generally be detected wherever a caries condition exists, is more pronounced in areas of incipient caries. This backscattered reflectance change is evident at early stages of caries, even when fluorescent effects are least pronounced.

The present invention takes advantage of the observed backscattering behavior for incipient caries and uses this effect, in combination with fluorescence effects described previously in the background section, to provide an improved capability for dental imaging to detect caries. The inventive technique, hereafter referred to as fluorescence imaging with reflectance enhancement (FIRE), not only helps to increase the contrast of images over that of earlier approaches, but also makes it possible to detect incipient caries at stages where preventive measures are likely to effect remineralization, repairing damage done by the caries infection at a stage well before more complex restorative measures are necessary. Advantageously, FIRE detection can be accurate at an earlier stage of caries infection than has been exhibited using existing fluorescence approaches that measure fluorescence alone.

### OCT Imaging

Optical coherence tomography (OCT) is a non-invasive imaging technique that employs interferometric principles to obtain high resolution, cross-sectional tomographic images of internal microstructures of the tooth and other tissue that cannot be obtained using conventional imaging techniques. Due to differences in the backscattering from carious and healthy dental enamel OCT can determine the depth of penetration of the caries into the tooth and determine if it has reached the dentin enamel junction. From area OCT data it is possible to quantify the size, shape, depth and determine the volume of carious regions in a tooth.

In an OCT imaging system for living tissue, light from a low-coherence source, such as an LED or other light source, can be used. This light is directed down two different optical paths: a reference arm of known length and a sample arm, which goes to the tooth. Reflected light from both reference and sample arms is then recombined, and interference effects are used to determine characteristics of the underlying features of the sample. Interference effects occur when the optical path lengths of the reference and sample arms are equal within the coherence length of the light source. As the path length difference between the reference arm and the sample arm is changed the depth of penetration in the sample is modified in a similar manner. Typically in biological tissues NIR light of around 1300 nm can penetrate about 3-4 mm as is the case with dental tissue. In a time domain OCT system the reference arm delay path relative to the sample arm delay path is alternately increased monotonically and decreased monotonically to create depth scans at a high rate. To create a 2-dimensional scan the sample measurement location is changed in a linear manner during repetitive depth scans.

### Imaging Apparatus

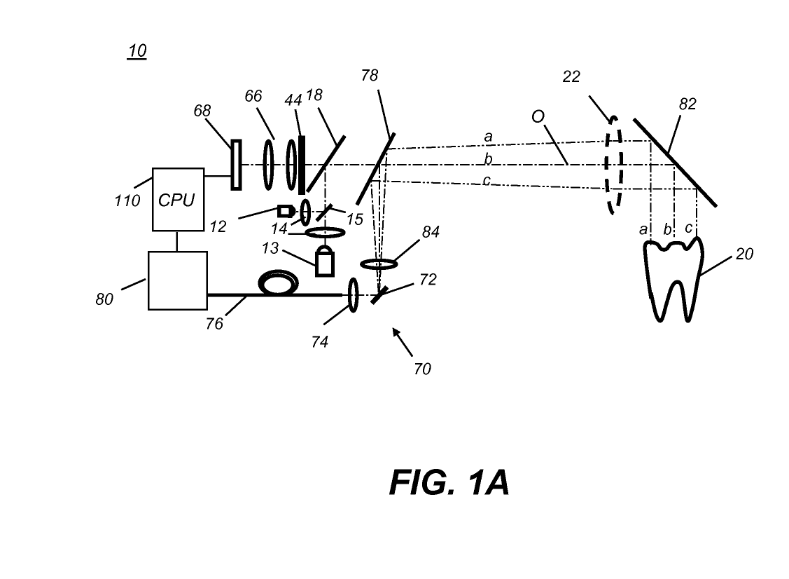

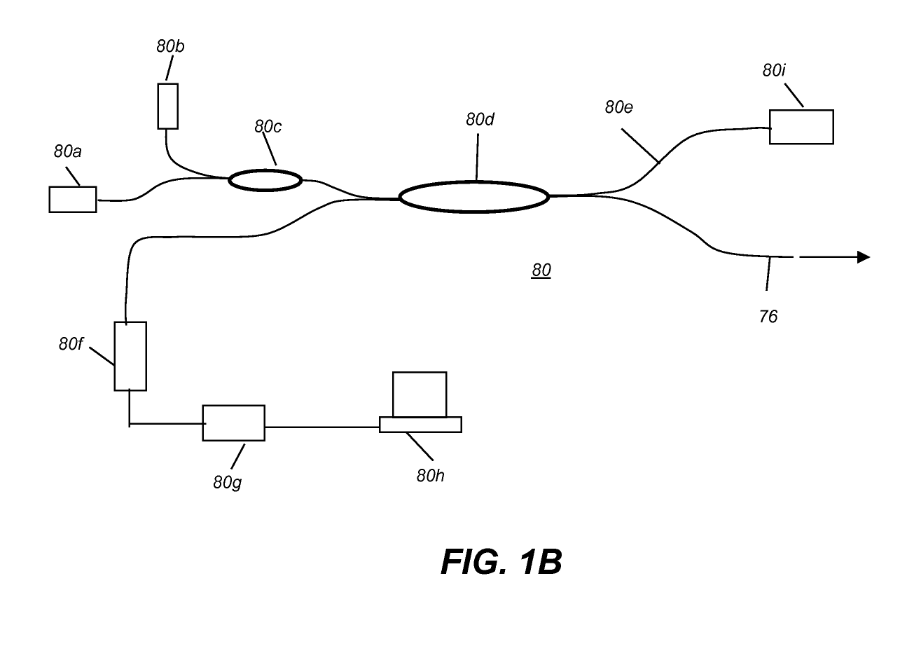

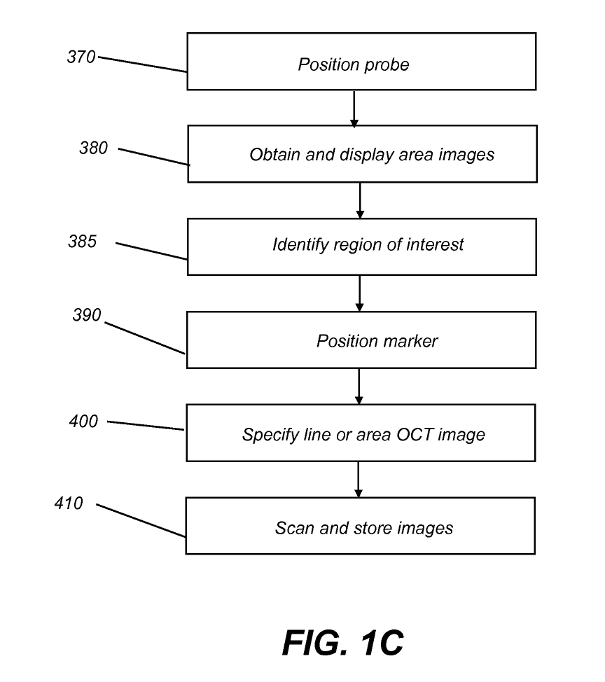

Referring to FIG. 1A, there is shown an imaging apparatus 10 using both FIRE imaging methods and OCT imaging according to one embodiment. As part of a surface area imaging system, a first light source 12 provides, through a lens 14, illumination in the visible spectrum. A light source combiner 15, such as a dichroic combiner, directs this light to a polarizing beamsplitter 18 (sometimes termed a polarization beamsplitter), which directs light of the desired polarization state through a dichroic combiner 78 along optical axis O and toward a turning mirror 82 that directs the light toward a tooth 20. An optional field lens 22 is provided to provide telecentric illumination and imaging conditions in tooth side. A second light source 13 provides, through its associated lens 14, light outside the visible spectrum, such as UV light used to excite fluorescence from tooth 20. Light from this second light source 13 is directed through light source combiner 15 to dichroic combiner 78 and along optical axis O. This light is also directed to tooth 20 for exciting a fluorescent response. Image-bearing light returned from tooth 20 then travels back along optical axis O, through dichroic combiner 78 to polarizing beamsplitter 18. Polarizing beamsplitter 18 advantageously performs the functions of both the polarizer for illumination from light sources 12 and 13, and the analyzer for image-bearing light, thus offering an efficient solution for polarization management. Tracing the path of illumination and image-bearing light shows how polarizing beamsplitter 18 performs this function. Illumination from each light sources is essentially unpolarized. In one embodiment, polarizing beamsplitter 18 transmits P-polarization, and reflects S-polarization, directing this light to tooth 20. At a caries infection site, backscattering depolarizes this light. Polarizing beamsplitter 18 treats the backscattered light in the same manner, transmitting the P-polarization and reflecting the S-polarization. The resulting P-polarized light can then be detected to form the surface area image at an imaging sensor 68. Because specular reflected light is S-polarized, polarizing beamsplitter 18 effectively removes this specular reflective component from the light that reaches sensor 68. The optics path to sensor 68 has a lens 66, such as a compound lens as shown, and a long-pass filter 44 to block the light which is from light source 12b to excite fluorescence. A control logic processor 110 obtains and processes the image from sensor 68.

Imaging apparatus 10 of FIG. 1A also includes an OCT imager 70. This includes an OCT system 80 that includes the light source, reference beam light path components, and other components familiar to those skilled in the OCT imaging arts. Light from OCT system 80 is directed through a sample arm optical fiber 76 and through a collimating lens 74 to a scanning element 72, such as a galvanometer or a micro-electro-mechanical system (MEMS) scanning device. Scanning element 72 can have 1 or preferably 2 axes. Light reflecting from scanning element 72 then passes through a scanning lens 84 and is incident onto dichroic combiner 78. Dichroic combiner 78 is designed to be transmissive to visible light and reflective for near-IR and longer wavelengths. This sample arm light is then reflected from dichroic combiner 78 to tooth 20 through optional field lens 22 and turning mirror 82. Scattered and reflected light returning from tooth 20 travels down the same optical path in reverse direction and is recombined with light from the reference arm (not shown) that is internal to OCT system 80. The multiple dashed lines labeled a, b, and c starting from scanning element 72 represent scan positions at different times during a single line scan and show that they are incident on and reflect from different locations of the tooth as shown in FIG. 1A. The position of scanning element 72 is controlled by control logic processor 110. For OCT scanning, the maximum distance of travel for the scan along any axis is determined by the usable aperture of scanning lens 84. Usually, raster scans are performed along a desired axis with increments in the perpendicular axis. The FIRE and OCT data are processed and controlled by control logic processor 110, which may include an external computer or workstation.

Light source 13 is typically centered around a blue wavelength, such as about 405 nm in one embodiment. In practice, light source 13 could emit light ranging in wavelength from an upper ultraviolet range to blue, between about 300 and 500 nm. Light source 13 can be a laser or could be fabricated using one or more light emitting diodes (LEDs). Alternately, a broadband source, such as a xenon lamp, having a supporting color filter for passing the desired wavelengths could be used. Lens 14 or other optical element may serve to condition the incident light, such as by controlling the uniformity and size of the illumination area. For example, a diffuser (not shown) might be used before or after lens 14 to smooth out the hot spots of an LED beam. The path of illumination light might include light guiding or light distributing structures such as an optical fiber or a liquid light guide, for example (not shown). Light level is typically a few milliwatts in intensity, but can be more or less, depending on the light conditioning and sensing components used.

FIG. 1B shows a diagram of the components of an example OCT system 80, which can be a time-domain or a Fourier-domain system. Light provided by OCT light source 80a can be a continuous wave low coherence or broadband light, and may be from a source such as a super-luminescent diode (SLD), diode-pumped solid-state crystal source, or diode-pumped rare earth-doped fiber source, for example. In one embodiment, near-IR light is used, such as light having wavelengths near 1310 nm, for example. Usually OCT light source 80a has the wavelength in near-infrared (NIR), for example, at around 1310 nm, in order to obtain enough depth inside the object under investigation. Alternatively, light source 80a can operate at around 850 nm. When working with a Fourier Domain instrument the OCT light source 80a can be a tunable laser diode. Optional visible light source 80b, at a different wavelength than light source 80a, aids in OCT scan visualization. This is useful to show where the OCT light is scanning on the tooth surface during line or area scans so that the practitioner can see where they are actually performing measurements. Light source 80b can be a visible laser or laser diode, LED, or other light source, for example centered on 650 nm. A 2-to-1 coupler 80c combines the light from light sources 80a and 80b and sends the light to a 2 by 2 coupler 80d, which also acts as the active element of the interferometer. After passing coupler 80d, the light from light sources 80a and 80b separates into a reference arm optical fiber 80e and a sample arm optical fiber 76. Light traveling down the reference arm optical fiber 80e is incident upon the reference delay depth scanner 80i. The purpose of the reference delay depth scanner, 80i is to change the path length of the reference arm of the interferometer relative to the sample arm. The reference delay depth scanner 80i includes a reflector (not shown), which causes the delayed light to travel back down reference arm optical fiber 80e. The light signals returned from reference and sample arms are recombined by 2 by 2 coupler 80d to form the interference signal. The interferometric is detected by detector and detection electronics 80f as a function of time. The detected signal is collected by a control logic processor 80h after processing though signal processing electronics 80g, for example, low pass filter and logarithm of the envelope of the interference signal amplifier. The detector 80f can either be a balanced detector or a single ended photodetector. If a balanced detector is used there is usually an optical circulator added to the OCT system 80 between elements 80c and 80d.

Many alternative configurations are possible for the OCT system 80. In order to increase the depth scanning capability and maintaining a high frequency of operation it can be desirable to have a depth scanning element in the sample arm as well as in the reference arm. The mechanism of operation of the reference delay depth scanner can be based on linear translation of retroreflective elements, varying the optical pathlength by rotational methods, use of piezoelectric driven fiber optic stretchers or based on group delay generation using Fourier Domain optical pulse shaping technology such as a Fourier Domain Rapid Scanning optical delay line. Many of these reference delay scanning alternatives are described in “Reference Optical Delay Scanning” by Andrew Rollins and Joseph Izatt in Handbook of Optical Coherence Tomography edited by Brett E Bouma and Guillermo J. Tearney, pp. 99-123, Marcel Dekker Inc. New York 2002.

Reference delay depth scanner 80i is used for a time-domain system. For a Fourier Domain OCT system, light source 80a can be either a broadband low-coherence super-luminescent diode (SLD), or a tunable light source. When the light source is an LED, detector and detection electronics 80f is an array of sensing elements in order to obtain the depth information. When a tunable light source is used, detector and detection electronics 80f includes a point detector; the depth information is obtained by tuning the wavelength of light source 80a and taking the Fourier transform of the data obtained as a function of wavelength.

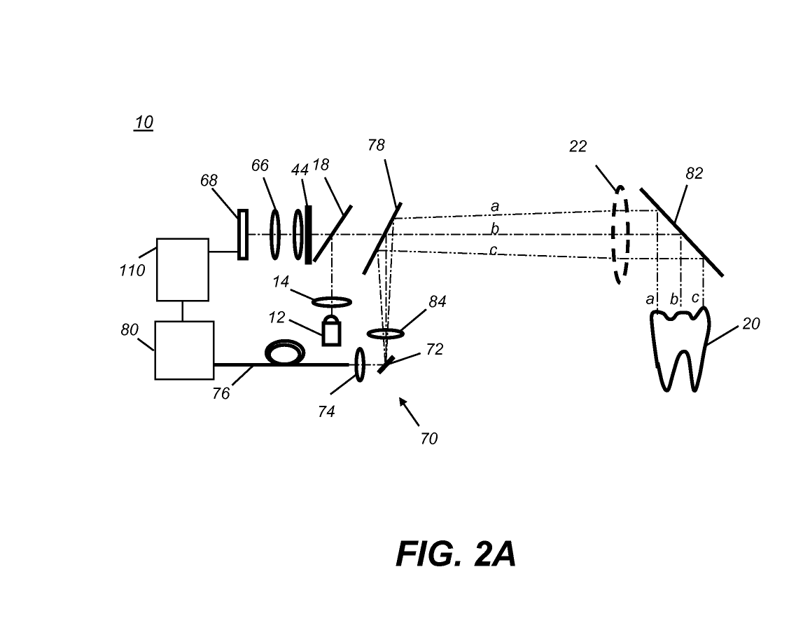

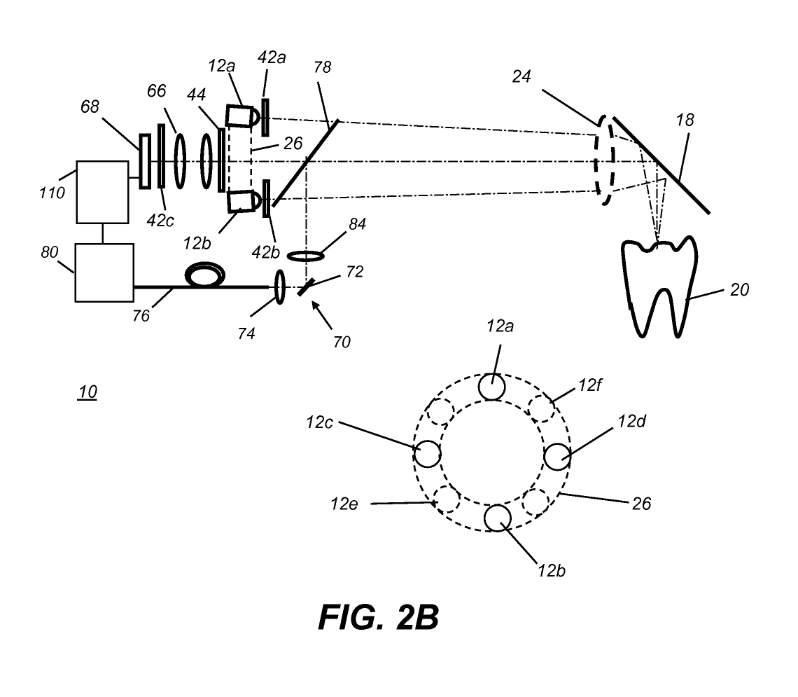

The schematic block diagram of FIG. 2A shows an alternate embodiment of imaging apparatus 10 using both FIRE imaging methods and OCT imaging with a similar arrangement and using only a single light source 12 for fluorescence imaging. A light source combiner is not needed. This embodiment can be used where only one type of area imaging is used in combination with OCT imaging. Alternately, light source 12 could be a white light source.

The schematic diagram of FIG. 2B shows an alternate arrangement for illumination in another embodiment of imaging apparatus 10. Here, multiple light sources 12a, 12b, 12c, 12d, 12e, and 12f are arranged to form an illumination ring 26. The light sources can be either ultraviolet light source or polychromatic light source. For example, light sources 12a-12d are polychromatic light, the others are ultraviolet light source. Illumination ring 26 has the arrangement shown, so that each light source 12a-12f can be separately provided, or some combination of light sources 12a-12f could be used. Each light source can have a corresponding polarizer, as shown by polarizers 42a and 42b, or bandpass filter to clean the spectrum. As shown in FIG. 2B, polarizers 42a and 42b are placed in front of light sources 12a and 12b to provide polarized light to illuminate the tooth. In order to remove the specular reflection from the tooth surface, an analyzer is necessary in the image path, as 42c in front of the sensor 68. With this configuration, the ultraviolet light sources are not polarized so that the light can be used more efficiently.

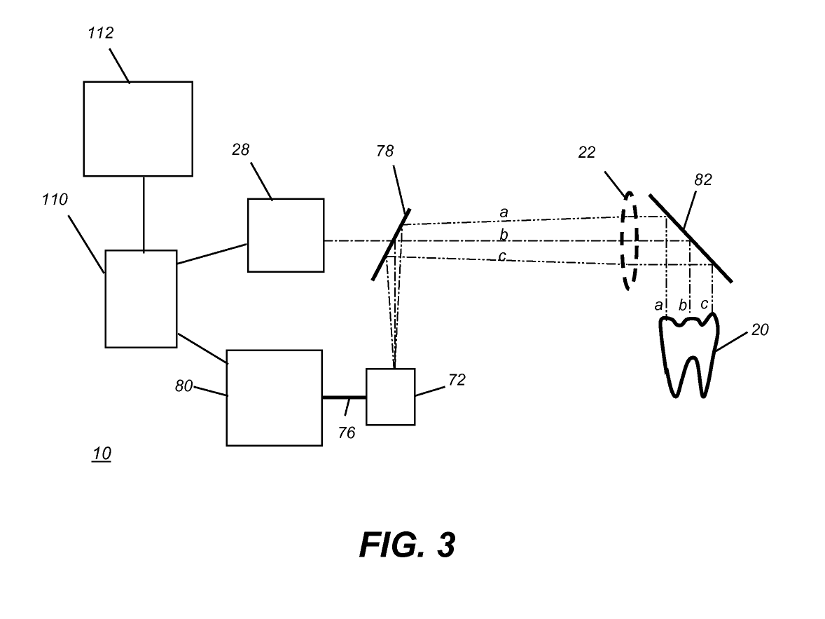

The generalized schematic diagram of FIG. 3 shows added components and component groupings for the various embodiments of imaging apparatus 10. Added components can include a display 112. Sensor support components 28 can include the image sensing and illumination components for surface image sensing described with reference to FIGS. 1A, 2A, and 2B.

The imaging optics, represented as field lens 22 in FIGS. 1A-3, could include any suitable arrangement of optical components, with possible configurations ranging from a single lens component to a multi-element lens. Clear imaging of the tooth surface, which is not flat but can have areas that are both smoothly contoured and highly ridged, requires that imaging optics have sufficient depth of focus. Preferably, for optimal resolution, the imaging optics provide an image size that substantially fills the sensor element of the camera. The use of telecentric optics is advantaged for field lens 22, providing image-bearing light that is not highly dependent on ray angle.

### Probe Embodiments

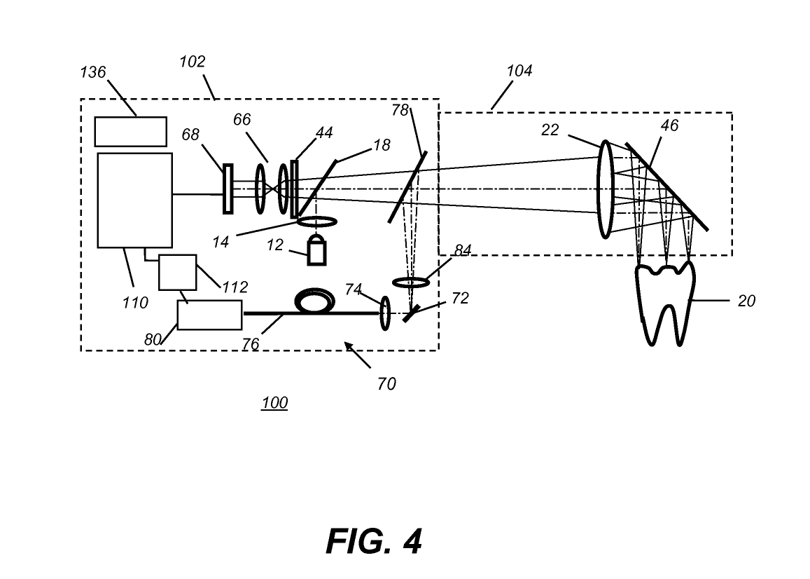

The components of a hand-held imaging apparatus 100 of the present invention can be packaged in a number of ways, including compact arrangements that are designed for ease of handling by the examining dentist or technician. Referring to FIG. 4, there is shown an embodiment of hand-held dental imaging apparatus 100 according to one embodiment of the present invention. Here, a handle 102, shown in phantom outline, houses light source 12, sensor 68, and their supporting illumination and imaging path components. A probe 104 attaches to handle 102 and may act merely as a cover or, in other embodiments, field lens 22 and turning mirror 46 in proper positioning for tooth imaging. Control logic processor 110 can include switches, memory, and control logic for controlling device operation. In one embodiment, control logic processor 110 can simply include one or more switches for controlling components, such as an on/off switch for light source 12. Optionally, the function of control logic processor 110 can be performed at one or more processing apparatus. In other embodiments, control logic processor 110 can include sensing, storage, and more complex control logic components for managing the operation of hand-held imaging apparatus 100. Control logic processor 110 can connect to an optional wireless interface 136 for connection with a communicating device, such as a remote computer workstation or server, for example. In the configuration shown in FIG. 4, OCT imager 70 is integrated into handle 102.

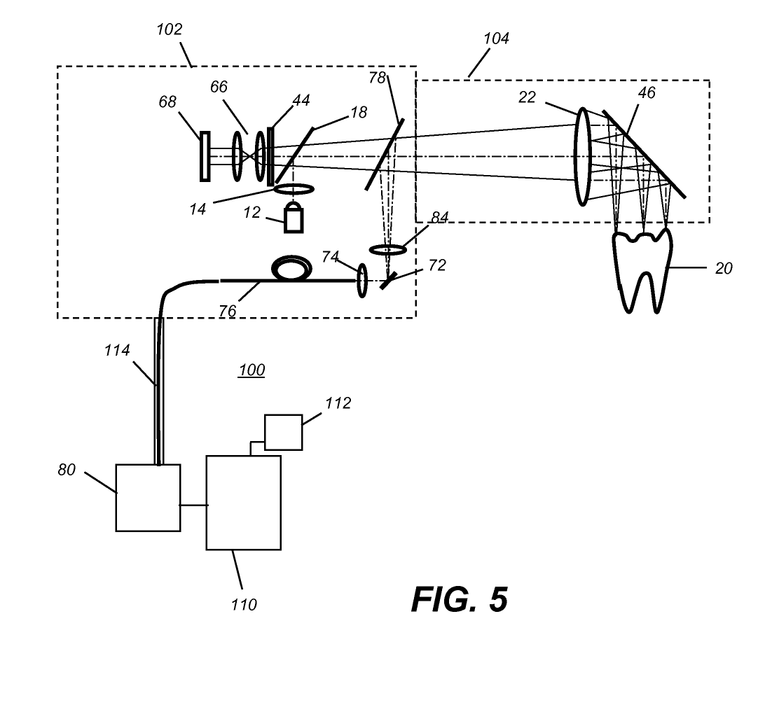

FIG. 5 is a block diagram showing an alternative embodiment of hand-held imaging apparatus 100 combining OCT with surface area imaging. In this embodiment, handle 102 has an imaging apparatus cable 114 that includes the sample arm, optical fiber 76 and necessary electrical cabling for communication with the OCT system 80 and control logic processor 110.

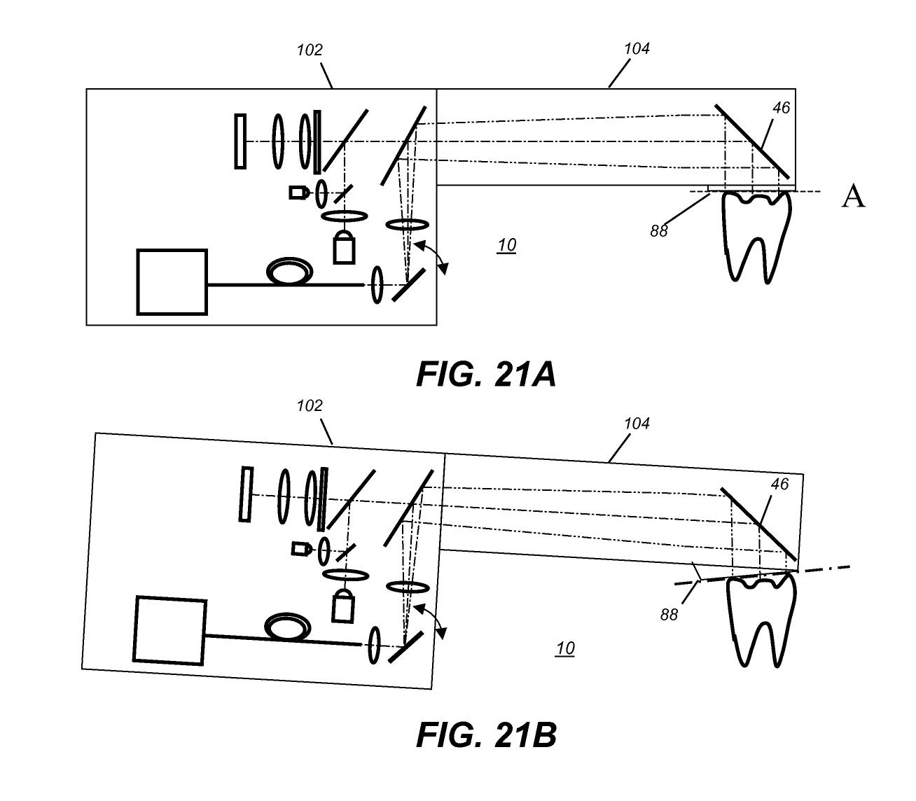

In one embodiment, probe 104 is removable and it is constructed so that it can be rotated to an arbitrary angle with respect to handle 102. Different probes can be interchanged for examining different types of teeth and for different sized mouths, as for adults or children as required. In addition, the handle can be optionally attached to a dentist's stand or instrument rack if desired. An added advantage of probe embodiments relates to maneuverability by the dental specialist. As shown in FIGS. 21A and 21B, the probe embodiment of imaging apparatus 10 allows improved imaging with tilt in some applications.

Dental imaging apparatus 100 may be configured differently for different patients, such as having an adult size and a children's size, for example. In one embodiment, removable probe 104 is provided in different dimensions for this purpose. Alternately, probe 104 could be differently configured for the type of tooth or angle used, for example. Probe 104 could be disposable or could be provided with sterilizable contact components. Probe 104 could also be adapted for different types of imaging. In one embodiment, changing probe 104 allows use of different optical components, so that a wider angle imaging probe can be used for some types of imaging and a smaller area imaging probe used for single tooth caries detection. One or more external lenses could be added or attached to probe 104 for specific imaging types.

### Operator Interface for Combined Area and OCT Imaging

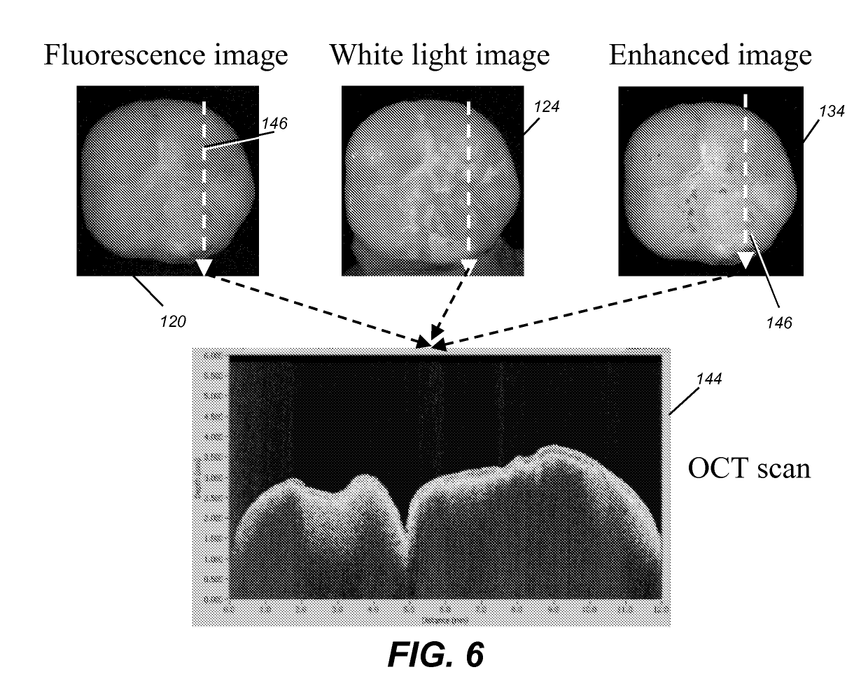

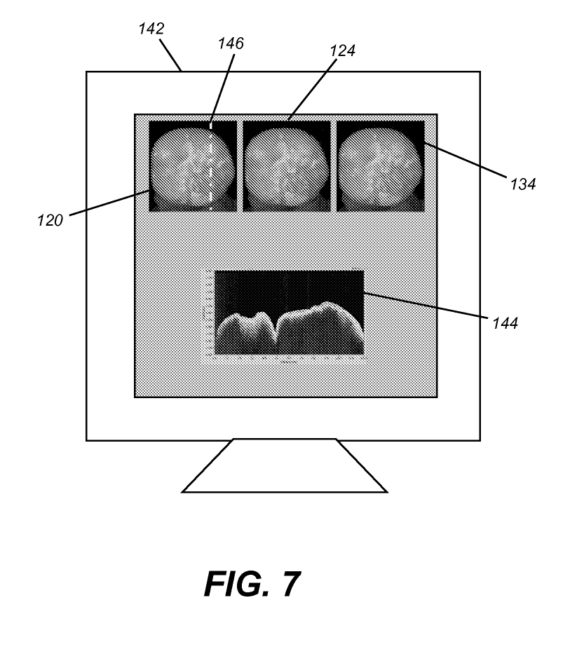

FIG. 6 shows an arrangement of surface area images and an OCT scan image that can be displayed to an operator. In one embodiment, two-dimensional area images and OCT images appear simultaneously on a display. Here, a fluorescence image 120, a white light image 124, and an enhanced composite image 134 are area images that show the tooth surface, as described previously. A marker 146 is displayed on at least one of the area images, indicating the location of an OCT scan image 144 and its scanning area. In the example shown in FIG. 6, mark 146 is a line, so that OCT scan image 144 has the appearance of a cross-sectional slice. In this example, OCT image 144 consists of 2000 measured points per depth scan of 6.0 mm total distance and 840 points along the horizontal scan line of total distance of 12 mm. As has been noted earlier, operator interaction with imaging system (not shown) can be used to specify the portion of tooth 20 that is to be imaged using OCT. The flow diagram of FIG. 1C shows a sequence of operator steps that are used to obtain an OCT image in one embodiment. In a probe positioning step 370, the operator, typically a dentist or dental technician, positions the probe against the tooth to be imaged. The probe is held against the tooth, in a stable position. This may be provided using a bite-down device or with some other type of stabilizing feature supporting the imaging end of the probe. An area imaging step 380 follows, during which one or more area images are generated and displayed on a display screen. Area images may be any proper subset of the set of images described earlier including white light image 124, fluorescence image 120, and composite image 134, for example. In the embodiment of FIG. 7, white light image 124, fluorescence image 120, and composite image 134 all are shown on a display 142 as area images. The operator may initiate capture of these images when the probe is positioned, such as by entering a command using a workstation keyboard or mouse selection or by pressing a control button on the probe itself. Alternately, the system may continuously (that is, repeatedly) perform this area imaging process, so that the operator continuously has a reference image displayed, enabling the operator to determine whether or not the probe is suitably positioned and the area image is in clear focus before proceeding to a later step.

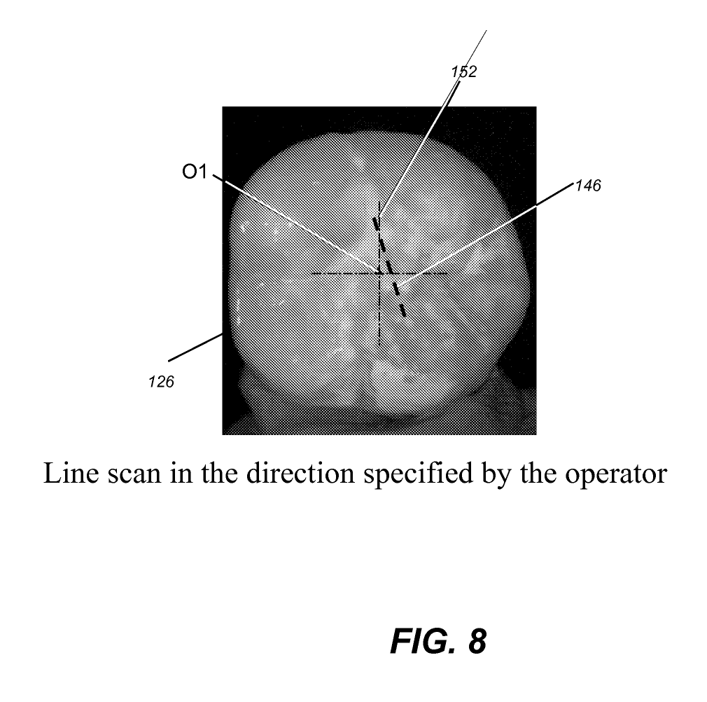

Once the oral imaging probe is in position and at least one area image displays, an identify a region of interest step 385 is performed. This can be performed automatically by imaging software or by the operator. Following identification of the region of interest step, a marker positioning step 390 is executed in which the location and area in the region of interest for the OCT scan is defined. As is shown in FIGS. 8, 9, 10, 11, and 12, crosshairs 152, a light indicator 148, or other reference can be positioned suitably with respect to the tooth. The light indicator can emanate from light source 80b and it could indicate the present location of the OCT scanning element 72 on the tooth. Preferably the OCT scanning position would be centered on the scanning lens 84 so as to maximize the possible scanning area during this step. Alternatively, the center of the crosshairs could indicate the center position of the OCT scanning range. For a line scan, operating a control such as a rotating thumbwheel on the oral imaging probe handle itself can be used to pivot marker 146 relative to crosshairs 152, light indicator 148, or similar reference. Optionally, a mouse or joystick could be used by the operator or a touch screen interface could be employed for accepting the operator instruction. In one embodiment, an OCT area image is simply defined by a fixed size rectangle that is centered with respect to the crosshairs 152 origin. The rectangle can be changed in size and orientation by appropriate instructions.

Then, in an OCT area specification step 400, the operator can specify whether a line scan or an area scan is desired as well as the direction, scan starting position, number of points in a scan and the total number of scans over the area. As an example the scan area selected, as described subsequently. Repetitive line scans will be performed on the tooth. The operator can select to start in the top left corner of the region and to scan left to right in a raster fashion with a 25 micron step size down the y axis as an example. The operator can also select the scan depth if desired. Typically for occlusal surfaces of molars it is recommended that the scanning depth be on the order of 6 mm to account for differences in height of a tooth surface in molars. After the OCT scanning region is identified the OCT scans are obtained as in step 410 of FIG. 1C. Typically the OCT displays are shown on the display screen in sequence as they are being generated.

FIGS. 8-12 show how the operator specifies the location and area of OCT scanning in different embodiments. As is shown in FIGS. 8-12, crosshairs 152, a light indicator 148, or other reference can be positioned suitably as various types of markers with respect to the tooth. Light indicator 148 can emanate from the OCT light source and could indicate the present location of the OCT scanning point on the tooth. Preferably the OCT scanning position would be centered on the scanning lens 84 so as to maximize the possible scanning area during OCT imaging procedure. Alternatively, the center of crosshairs 152 could indicate the center position of the OCT scanning area. Where the scanning area is a line scan, a rotating thumbwheel on the probe itself can be used to pivot marker 146 relative to crosshairs 152, light indicator 148, or similar reference. Optionally, a mouse or joystick could be used by the operator or a touch screen interface could be employed for accepting the operator instruction. In one embodiment, an OCT volume image is simply defined by a fixed size rectangle that is centered with respect to the crosshairs 152 origin. The rectangle can be changed in size and orientation according to operator instructions.

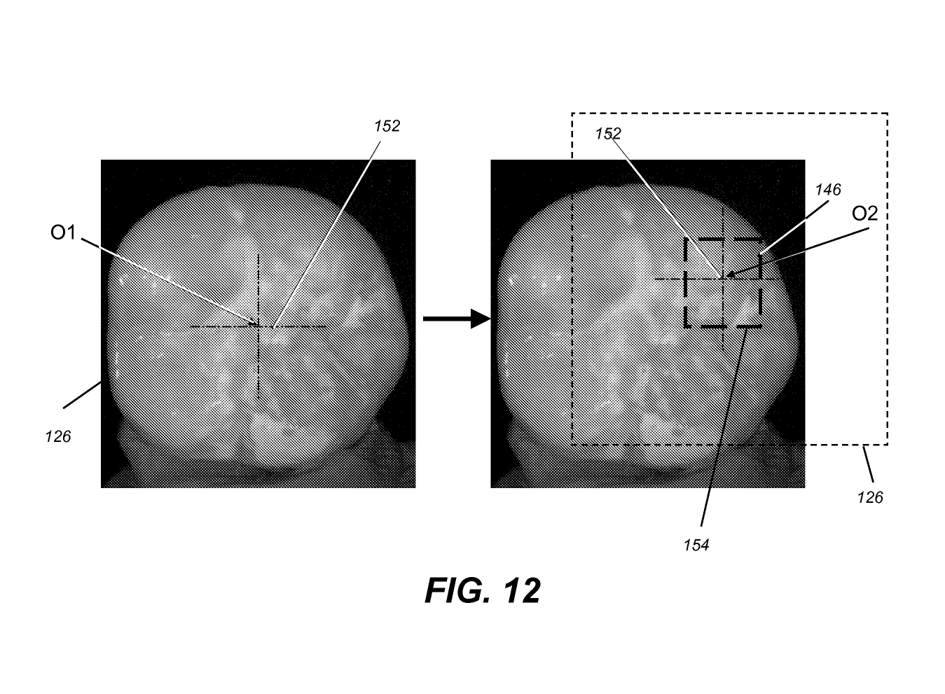

The operator can specify whether the scanning area requires a single line scan or a multiple-line volume scan, as well as the direction and density of measured points in the scan. When a volume image is selected for the scanning area, the density of adjacent scans is also selected. As an example, scan area 154 selected in FIG. 12 is a 4 mm square region. Repetitive OCT line scans are performed on the tooth to form the volume scan. For example, the operator can elect to start in the top left corner of the region, to scan left to right in a raster fashion, and to use a 25 micron step size down the y axis. The operator can also select the scan depth if desired. Typically for occlusal surfaces of molars it is recommended that the scanning depth be on the order of 6 mm to account for differences in height of a tooth surface in molars.

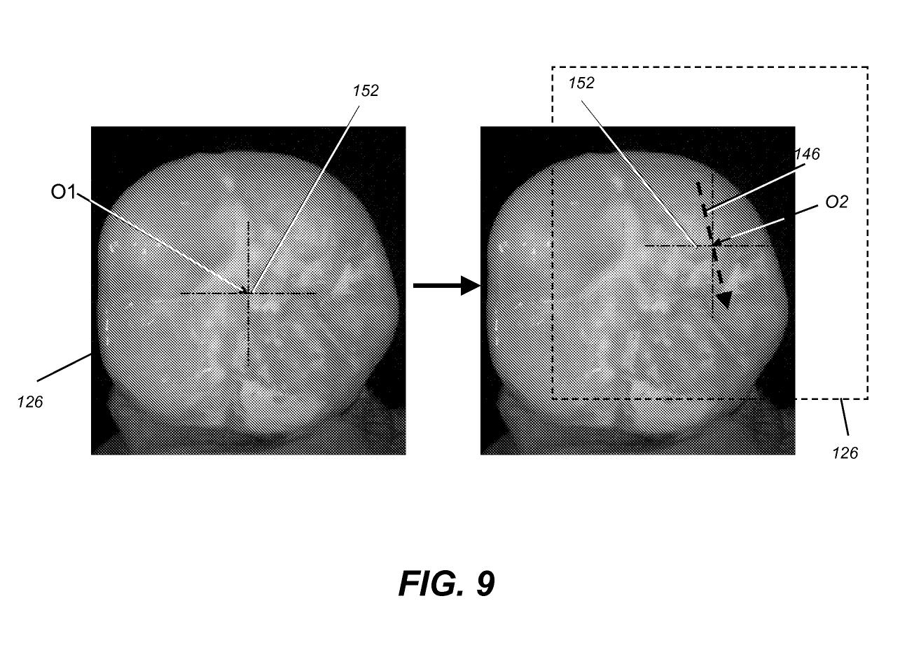

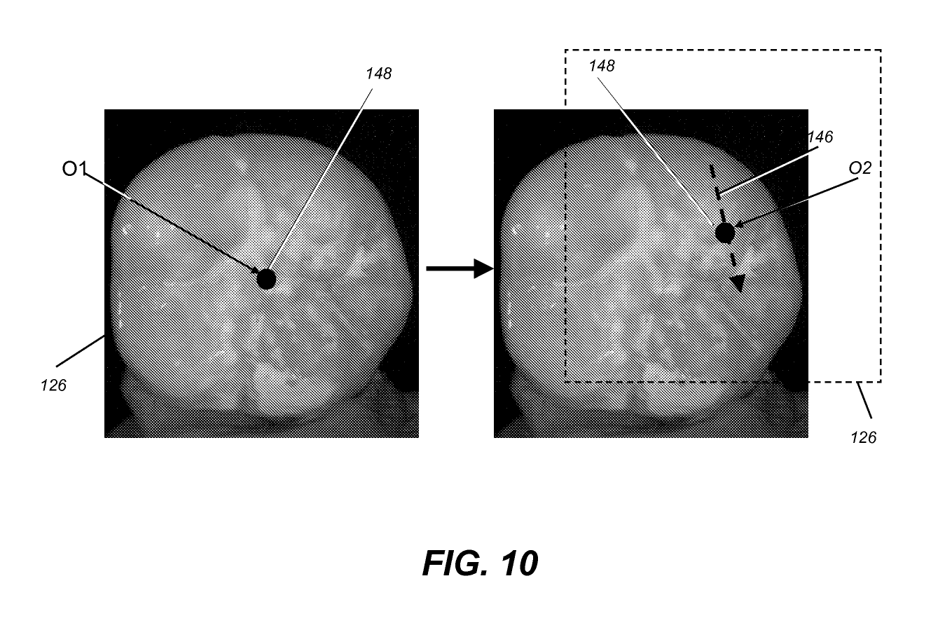

FIGS. 8-12 show how the operator can specify the location and area of the OCT scan in different embodiments. For these examples, the optical axis of the OCT scanning components is the same as the optical axis for area imaging. As shown in FIGS. 8-12, some type of target is provided on an area image displayed in a live window 126 in order to indicate the location of this optical axis. In FIG. 21A, for example, crosshairs 152 indicate the optical axis location on an area image, at a reference point O 1. The optical axis indicates a center point for the OCT scan. The operator can move crosshairs 152 or other target in order to center this reference at a desired point on the tooth. For instance, as shown in FIG. 9, crosshairs 152 can be moved by the operator to a second reference point 02 as the target for OCT scanning. As noted earlier, the area image that displays in a live window 126 and permits repositioning of crosshairs 152 or other target can be composite image 134 or any of its component images, such as an x-ray image or white light image 124, for example. As shown in FIG. 10, light indicator 148 may be provided as an alternative target type, instead of crosshairs 152. Light indicator 148 can be generated by light from the probe itself, such as a laser or LED can provide. The OCT light source could also be used for this purpose.

Within live image 126, marker 146 is provided, positioned relative to crosshairs 152 or other target. Marker 146 identifies the scan area or line scan direction and can also be repositioned by the operator. In one embodiment, marker 146 is movable over a small range of dimensions, corresponding to the dimensions that can be reached by OCT scanning with the optical axis in the current position. This is determined by the maximum clear aperture of scanning lens 84 and scanning element 72. Thus, an operator attempts to move marker 146 beyond the area that can be scanned by OCT optics can be defeated by control logic. In order to move marker 146 outside of this range, it is necessary for the operator to first reposition the probe so that the optical axis indicated by crosshairs 152 or light indicator 148 is roughly in the center of the region that requires OCT scan, as shown in FIGS. 9 and 10. Alternatively the probe may have built-in repositioning capability to automatically center the probe OCT scan center on the desired marker position.

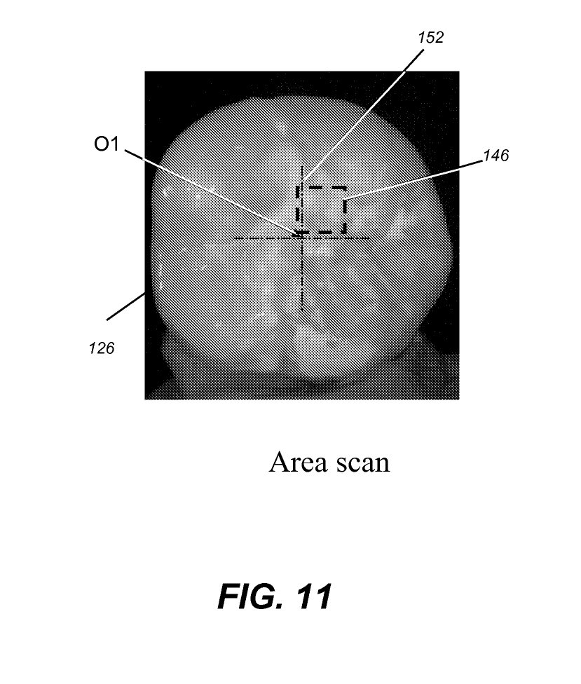

In FIGS. 8-10 marker 146 indicates that the OCT scan is a line scan and shows the position and angular orientation of the line, both of which can be readjusted by the operator. In FIGS. 11 and 12, marker 146 designates a volume scan that may be repositioned and resized but, in one particular embodiment, has a fixed rectangular shape and size. In other embodiments, these volume scans can have other cross-sectional shapes, such as circular, polygonal, or operator-defined shapes and may be adjustable in size.

One advantage of light indicator 148 relates to its correspondence to the optical axis of the scanning probe. In one embodiment, light indicator 148 can also visibly track the OCT scanning action, showing the operator, by means of live window 126 display, the actual location of the OCT sample beam at any point in the scan.

Initiation of the OCT scan can begin with a button press on the probe or with some other mechanism for obtaining an operator instruction, including a voice-actuated mechanism, for example. Automatic generation of the OCT image is also possible, based on image processing of the area image and automated detection of a region of interest from the area image.

Once the OCT image is generated, whether following an operator instruction or automatically, the OCT image is displayed to the operator. An optional storage operation can follow, in which image data for the OCT image and any of the area images can be stored for later use or further processed.

### Auto Focus

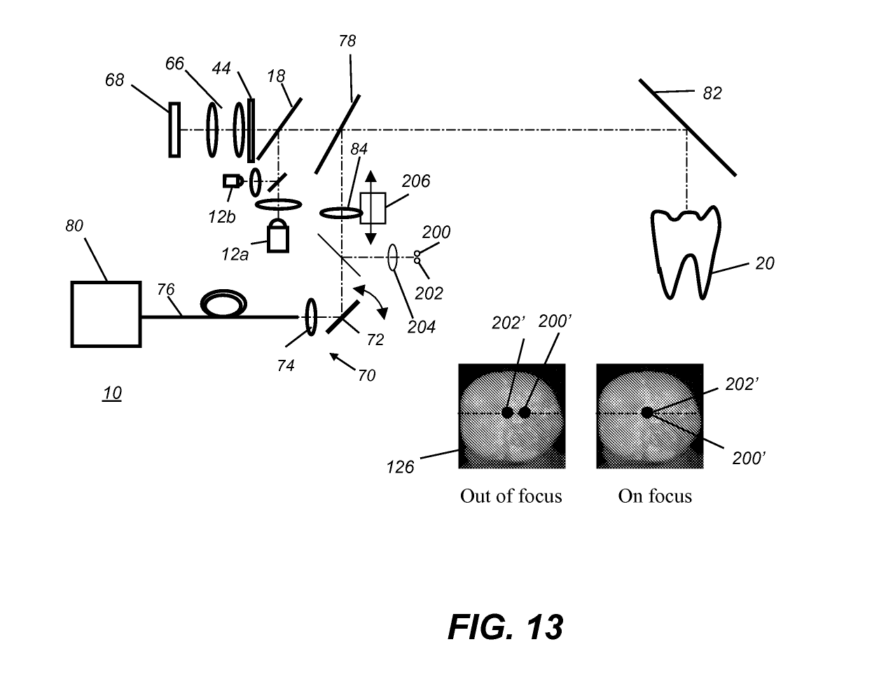

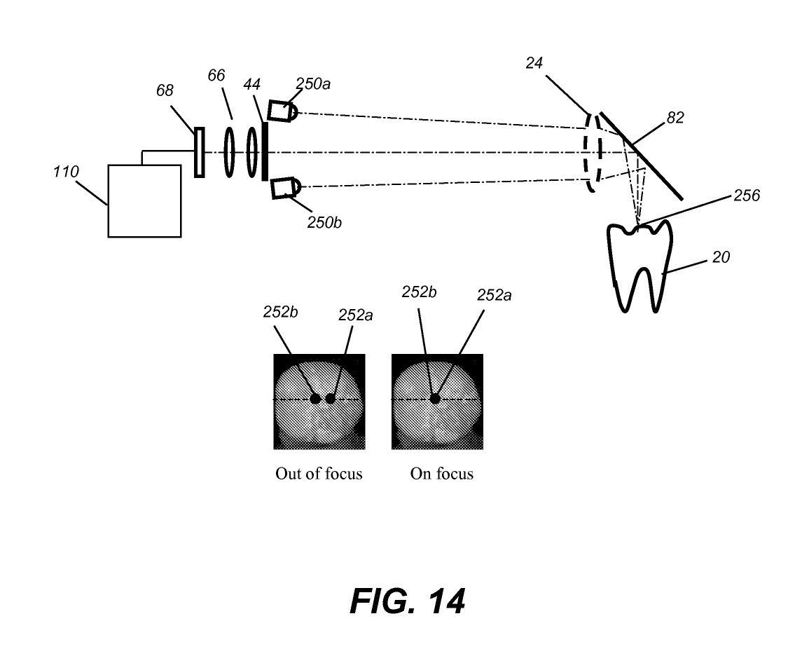

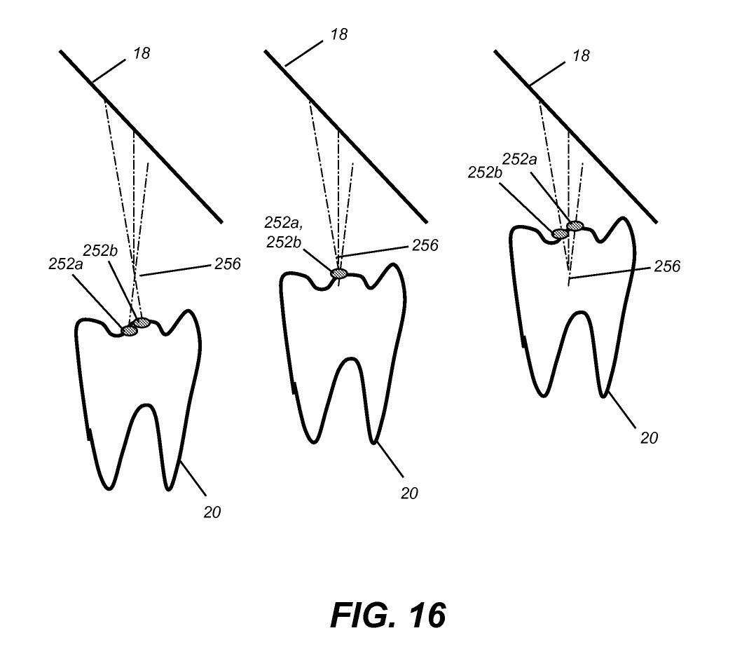

In some cases, the tooth surface, particularly the occlusal surface, can have a high degree of variation or the surface can be too large, so that depth information of OCT image is limited. Auto focus can be used to compensate in such a situation. The apparatus of the present invention provides auto focus by imaging multiple light sources onto the tooth surface and aligning or overlapping the images formed from these light sources. Referring to FIG. 13, there is shown an auto focus embodiment using this method. Light sources 200 and 202 are collimated by a lens 204 and directed toward tooth 20 in order to adjust the position of lens 84. Images 200′ and 202′ from light sources 200 and 202 respectively display on live window 126. The position of lens 84 is adjusted, such as by an automated actuator 206, until images 200′ and 202′ overlap. FIG. 14 shows an alternate embodiment using light sources 250a and 250b to achieve focus in a similar manner, using their corresponding images 252a and 252b. FIG. 16 shows, from a side view, how this overlap of images 252a and 252b works. A focal point 256 is indicated for imaging probe optics. At left, focal point 256 lies above tooth 20. At the right, focal point 256 lies below the surface of tooth 20. At center, focal point 256 is properly located on the surface of tooth 20 and images 252a and 252b overlap.

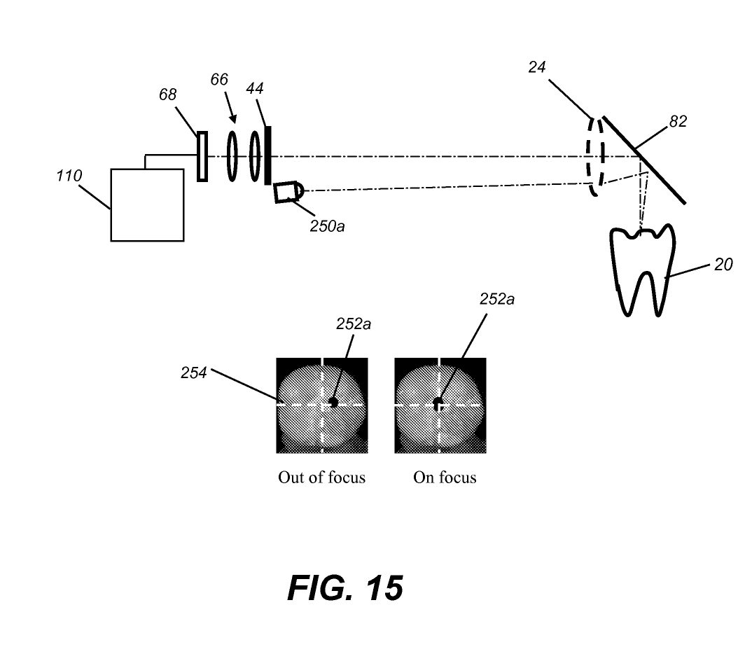

FIG. 15 shows an auto focus embodiment that employs a single light source 250a and a target 254 that is centered on the tooth. In this embodiment, the centering of image 252a indicates that auto focus is achieved.

### Alternative Probe Embodiments

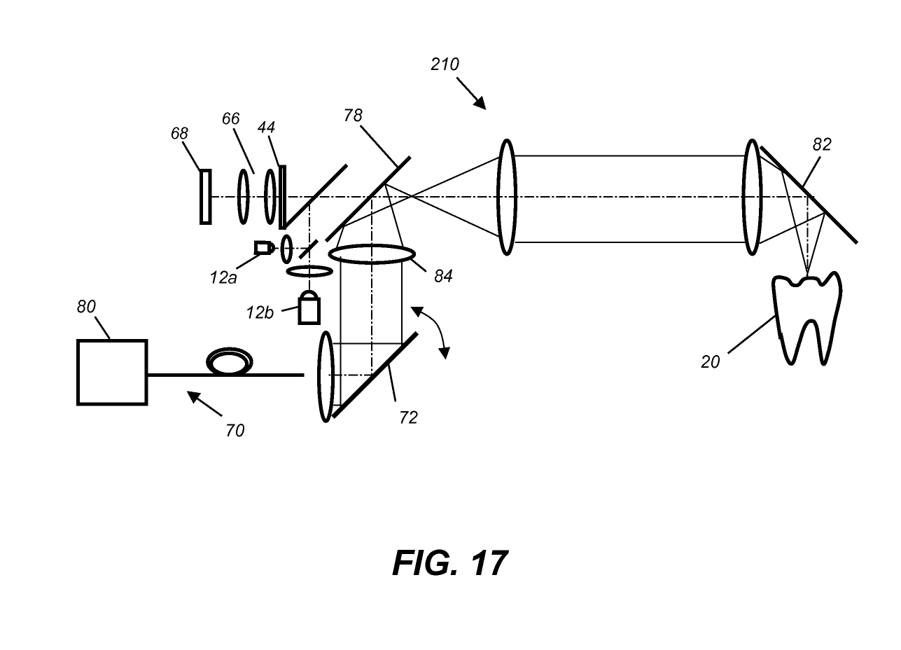

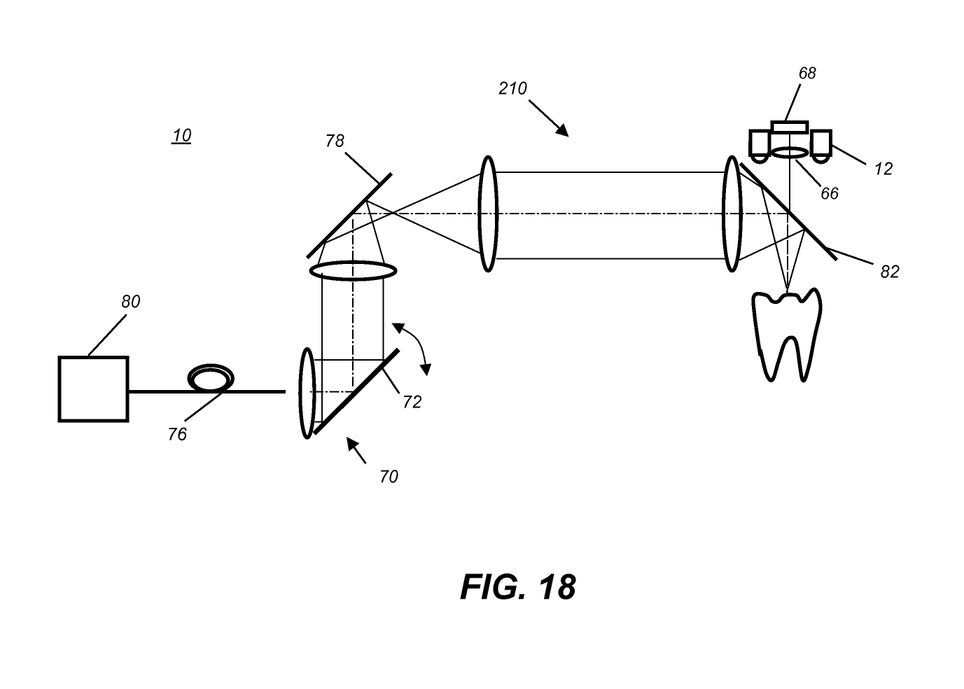

FIG. 17 shows a schematic diagram of imaging apparatus 10 using a relay lens 210 in the path of illumination and image light. This arrangement provides improved numerical aperture (NA) with smaller lenses and thus allows higher resolution. FIG. 18 shows a schematic diagram of imaging apparatus 10 having OCT capabilities and using relay lens 210. In this embodiment, the area imaging lens 66 and imaging sensor 68 are placed in the front end of the probe. The light sources 12 are also built around the imaging lenses to provide illumination to the tooth. Element 82 in this embodiment can be a polarization beamsplitter to remove the specular reflection from the reflectance image.

### Fiber Optic Scanners

Resonant fiber optics have been used for scanning in a number of different applications. For example, U.S. Pat. No. 6,563,105 (Seibel et al.) describes use of a resonating fiber for illuminating and collecting light in a medical imaging device. Other devices and methods for using fiber optic scanning are noted in U.S. Pat. No. 6,959,130 (Fauver et al.) and in U.S. Pat. No. 6,975,898 (Seibel).

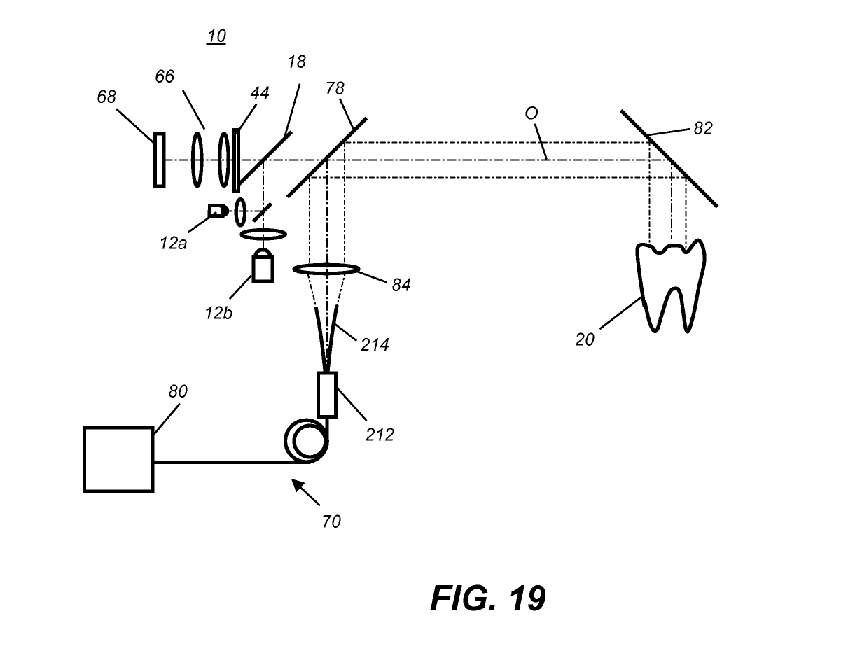

FIG. 19 shows an embodiment of imaging system 10 using a fiber optic scanner 212 as its scanning element in the OCT imaging path. A resonating fiber 214 scans at high speed, directing light through lens 84 and along the optical axis O. Light returned from tooth 20 is redirected through the fiber and used in OCT system 80. Fiber optical scanner has the advantage of compact, low cost, and ease to implement.

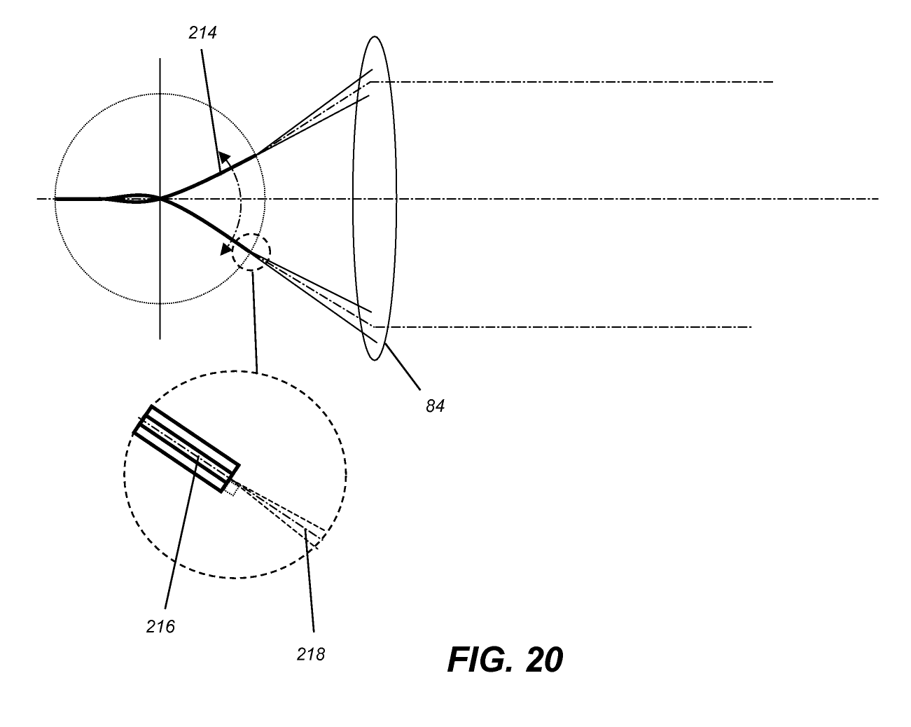

FIG. 20 shows the optical layout of the fiber optical scanner. The fiber 214 is actuated by piezoelectric tube actuator or other methods, such as magnetic based actuator, allowing light projected from the fiber to be focused onto the tooth by scanning lens 84. The scanning angle is controlled by the applied voltage according to the size of the region of interest. The light reflected back from the tooth is collected by the fiber 214 through the lens 84 and delivered to the detector in OCT system. In order to achieve high collection efficiency, the scanning lens 84 is designed so that the chief ray 218 of the light reflected back from the tooth coincides with the optical axis 216 of the fiber. In this configuration, all the light from the fiber is focused on the tooth and the highest coupling efficiency of the reflected light into the fiber is obtained.

FIGS. 21A and 21B are the two embodiments of the probe design. FIG. 21A shows that the contact surface 88 probe is parallel to the optical axis of the imaging system. When the user takes the tooth images, the contact surface 88 sits on the tooth surface to keep the probe stable during the image capturing, as well as maintain the working distance. Probe stabilization is very important for OCT scanning since its high resolution requirement. The contact surface 88 in FIG. 21B is tilted relative to the optical axis of the imaging system with a better ergonomic.

In the above discussions the area images and OCT images are described as if from a single tooth. The description of the methods and apparatus can readily be extended to more than one tooth. In particular, it is of interest to investigate interproximal caries which forms at the junction between two adjacent teeth. Thus, all of the above area image descriptions can be extended to include area images of multiple teeth. Furthermore, it is not necessary that the area image of a tooth require that there is an image of an entire tooth surface. It is understood that the area images can be of partial teeth since the entire tooth may not be in the field of view.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

For example, various types of light sources 12 could be used, with various different embodiments employing a camera or other type of image sensor. While a single light source 12 could be used for fluorescence excitation, it may be beneficial to apply light from multiple incident light sources 12 for obtaining multiple images. Supporting optics for both illumination and image-bearing light paths could have any number of forms. A variety of support components could be fitted about the tooth and used by the dentist or dental technician who obtains the images. Such components might be used, for example, to appropriately position the light source or sensing elements or to ease patient discomfort during imaging.

Thus, what is provided is an apparatus and method for caries detection using low coherence OCT imaging over a region of interest defined by taking a surface area image of a tooth.

### PARTS LIST

10 imaging apparatus
12 light source
12a light source
12b light source
12c light source
12d light source
12e light source
12f light source
13 light source
14 lens
15 light source combiner
18 polarizing beamsplitter
20 tooth
22 field lens
26 illumination ring
28 sensor support components
42a polarizer
42b polarizer
42c analyzer
44 filter
46 turning mirror
66 lens
68 sensor
70 OCT imager
72 scanning element
74 lens
76 sample arm optical fiber
78 dichroic combiner
80 OCT system
80a OCT light source
80b visible light source
80c coupler
80d coupler (interferometer)
80e reference arm optical fiber
80f detector and detection electronics
80g signal processing electronics
80h control logic processor
80i reference delay depth scanner
82 turning mirror
84 scanning lens
88 contact surface
100 imaging apparatus
102 handle
104 probe
110 control logic processor
112 display
114 imaging apparatus cable
120 fluorescence image
124 white light image
126 live window
134 composite image
136 wireless interface
142 display
144 OCT scan image
146 marker
148 light indicator
152 crosshairs
154 scan area
200 light source
202 light source
200′ image
202′ image
204 lens
206 automated actuator
210 relay lens
212 scanner
214 fiber
216 optical axis of fiber
218 chief ray of the scanning lens
250a light source
250b light source
252a image
252b image
254 target
256 focal point
370 probe positioning step
380 area imaging step
385 identify region of interest step
390 marker positioning step
400 OCT area specification step
410 storage step

1. An apparatus having an optical axis, for obtaining an image of a tooth comprising:
a) an image sensor for obtaining a visible light image which comprises a white light image, a fluorescent light image, or both;
b) a white light source providing broadband polychromatic light for obtaining the white light image;
c) an ultraviolet light source providing narrow-band light for obtaining the fluorescent light image;
d) a light beam combiner disposed to direct the broadband polychromatic light from the white light source and the narrow band light from the ultraviolet light source along a common illumination path to illuminate the tooth;
e) a polarization beamsplitter disposed to direct polarized light from the illumination path along the optical axis as polarized illumination;
f) an optical coherence tomography (OCT) imaging apparatus comprising a low coherence light source and light guiding components that split the low coherence light into a sample path low coherence light and a reference path low coherence light;
g) a dichroic element disposed to direct the polarized illumination and the sample path low coherence light along the optical axis;
h) an image processor programmed to identify a region of interest of the tooth according to either the white light image, the fluorescent light image, or both; and
i) a control logic processor programmed to actuate the OCT imaging apparatus to obtain an OCT image over the region of interest.

2. The apparatus of claim 1 further comprising a scanner for scanning the sample path low coherence light toward the tooth.

3. The apparatus of claim 2 wherein the scanner comprises an optical fiber.

4. The apparatus of claim 1 further comprising a imaging lens for obtaining a visible light image which comprises a white light image, a fluorescent light image, or both.

5. An apparatus having an optical axis, for obtaining an image of a tooth comprising:
a) an image sensor for obtaining a visible light image which comprises a white light image, a fluorescent light image, or both;
b) a white light source providing broadband polychromatic light for obtaining the white light image;
c) an ultraviolet light source providing narrow-band light for obtaining the fluorescent light image;
d) a first polarization element disposed in the optical path of the white light source to direct polarized light onto the tooth;
e) a second polarization element disposed in the imaging path to attenuate specular reflection from the tooth surface;
f) an optical coherence tomography (OCT) imaging apparatus comprising a low coherence light source and light guiding components that split the low coherence light into a sample path low coherence light and a reference path low coherence light;
g) a dichroic element disposed to direct the polarized illumination and the sample path low coherence light along the optical axis;
h) an image processor programmed to identify a region of interest of the tooth according to either the white light image, the fluorescent light image, or both; and
i) a control logic processor programmed to actuate the OCT imaging apparatus to obtain an OCT image over the region of interest.

6. An apparatus having an optical axis, for obtaining an image of a tooth comprising:
a) an image sensor for obtaining a visible light image which comprises a white light image, a fluorescent light image, or both;
b) a white light source providing broadband polychromatic light for obtaining the white light image;
c) an ultraviolet light source providing narrow-band light for obtaining the fluorescent light image;
d) a light beam combiner disposed to direct the broadband polychromatic light from the white light source and the narrow band light from the ultraviolet light source along a common illumination path to illuminate the tooth;
e) one or more polarization elements disposed in the illumination path and imaging path to eliminate specular reflection;
f) an optical coherence tomography (OCT) imaging apparatus comprising a low coherence light source and light guiding components that split the low coherence light into a sample path low coherence light and a reference path low coherence light;
g) a dichroic element disposed to direct the polarized illumination and the sample path low coherence light along the optical axis;
h) an image processor programmed to identify a region of interest of the tooth according to either the white light image, the fluorescent light image, or both; and
i) a control logic processor programmed to actuate the OCT imaging apparatus to obtain an OCT image over the region of interest.

7. An apparatus for making automatic focus adjustment for optical coherence tomography (OCT) scanning comprising:
a) an image sensor for obtaining an image;
b) a first light source providing a first collimated light beam;
c) a second light source providing a second collimated light beam;
d) a scanning lens for focusing the first and the second collimated beams on a surface;
e) a control logic processor which determines positions of the first and the second collimated beams based on said image;
f) a device for moving the lens to overlap the first and the second collimated beams on the surface.

8. The apparatus of claim 7 wherein the image is reflected from the surface.

9. The apparatus of claim 7 wherein the surface is a tooth surface.

10. An optical coherence tomography (OCT) imaging apparatus comprising:
a) an image sensor;
b) a low coherence light source;
c) light guiding components that split the low coherence light into a sample path low coherence light and a reference path low coherence light;
d) a scanning optical fiber optically coupled to the sample path to scan the low coherence light on a surface; and
e) a scanning lens in the path of light from the scanning optical fiber, wherein a chief ray of the lens lies along an optical axis of the scanning optical fiber.

11. The apparatus of claim 10 wherein the surface is a tooth surface.
